(19) United States
(12) Patent Application Publication
(10) Pub. No.: US 2023/0241893 A1
(43) Pub. Date: Aug. 3, 2023

(54) MAINTAINING NOZZLES OF PRINT APPARATUSES

(71) Applicant: Hewlett-Packard Development Company, L.P., Spring, TX (US)

(72) Inventors: Andreu CORTES, Sant Cugat del Valles (ES); Estefania SERRANO LOPEZ, Sant Cugat del Valles (ES); Guillem ROIG HERNANDEZ, Sant Cugat del Valles (ES); Chandrasekhar Venkata NADIMPALLI, Sant Cugat del Valles (ES); Pol VINARDELL SERRASOLSAS, Sant Cugat del Valles (ES); Jordi BLANCH I PUJOL, Sant Cugat del Valles (ES)

(73) Assignee: Hewlett-Packard Development Company, L.P., Spring, TX (US)

(21) Appl. No.: 17/906,926

(22) PCT Filed: Mar. 24, 2020
(86) PCT No.: PCT/US2020/024407

§ 371 Date: Sep. 21, 2022

(51) Int. Cl. B41J 2/165

(52) U.S. Cl. CPC B41J 2/16538

(57) ABSTRACT

A print apparatus is disclosed. The print apparatus comprises a print agent distributor having a plurality of nozzles through which print agent is to be delivered during a printing operation. The print apparatus also comprises a maintenance unit having a print agent receiving surface to receive print agent from nozzles of the print agent distributor during a maintenance event. During the maintenance event, the print agent receiving surface and the plurality of nozzles are to contact one another and move relative to one another in a first direction and in a second direction which is not parallel to the first direction, such that print agent is transferred from nozzles of the print agent distributor onto the print agent receiving surface. A method and a machine-readable medium are also disclosed.

### BACKGROUND

Some print apparatus use a print agent distributor to deliver print agent, such as ink, onto a printable substrate. As the print agent distributor scans over the printable substrate, drops of ink may be delivered through nozzles of the print agent distributor in accordance with a printing pattern defined in image data, to form an image on the printable substrate.

During the printing process, residual ink which has not be deposited onto the printable substrate may remain in the nozzles and, if left, may dry and cause the nozzles to become blocked.

### BRIEF DESCRIPTION OF DRAWINGS

Examples will now be described, by way of non-limiting example, with reference to the accompanying drawings, in which:

FIG. 1 is a schematic illustration of an example of a print apparatus;

FIG. 2 is a schematic illustration of a further example of a print apparatus;

FIG. 3 is a schematic illustration of an example of a maintenance unit of the print apparatus of FIG. 2;

FIG. 4 is a schematic illustration of an example of part of the maintenance unit of FIG. 3;

FIG. 5 is an illustration of an example of an output of the maintenance unit of FIG. 3;

FIG. 6 is a flowchart of an example of a method wiping nozzles;

FIG. 7 is a flowchart of a further example of a method wiping nozzles; and

FIG. 8 is a schematic illustration of an example of a processor in communication with a computer-readable medium.

### DETAILED DESCRIPTION

Examples disclosed herein may be applicable to all types of printing in which print agent (sometimes referred to as printing fluid), such as ink, is delivered onto a surface using a print agent distributor (sometimes referred to as a print head). Examples are applicable to two-dimensional (2D) print systems, such as inkjet print systems, in which ink is deposited onto a printable substrate via nozzles of a print head. Similarly, examples are applicable to three-dimensional (3D) print systems, also referred to as additive manufacturing systems, in which three-dimensional objects are generated.

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber.

In some examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern. The print agent may be deposited onto the build material via nozzles of a print agent distributor. The nozzles may be arranged in groups formed on or forming part of one or more dies.

When print agent is deposited from nozzles of a print agent distributor during a printing operation, some print agent may remain in or at the ends of the nozzles, and this residual print agent may dry and cause nozzles to become blocked or, at least, create unwanted effects on future print agent depositions through such nozzles. Various techniques are used to remove print agent from the nozzles before it dries. A spitting procedure may be used to fire print agent through the nozzles into a spitting region (e.g. a spittoon) so as to clear the nozzles. The nozzles may also be wiped to remove residual print agent from the ends of the nozzles. In an example of such a wiping procedure, the print agent distributor is moved such that the nozzles are brought into contact with a wiping surface. The print agent distributor is then moved such that the nozzles are wiped over the wiping surface. In some examples, the wiping surface may comprise a wicking material such that print agent present at the ends of nozzles is wicked away from the nozzles and wiped onto or absorbed by the wiping surface.

If the nozzles are wiped in a single direction (e.g. in a straight line), some print agent may accumulate on the print agent distributor, at locations adjacent to or near to the nozzles. Over time, accumulated print agent may dry and continue to collect at particular regions of the print agent distributor. Eventually, the dried print agent may interfere with the nozzles, resulting in the occurrence of a print defect. It has been recognized, therefore, that the amount of print agent accumulating on the print agent distributor can be reduced if the nozzles are wiped on the wiping surface in multiple directions during the wiping procedure. Thus, according to examples disclosed herein, nozzles of a print agent distributor are wiped in at least two non-parallel directions, such that print agent is distributed over a larger area of the wiping surface, and such that the nozzles are wiped in multiple directions, not just in a single direction. In this way, print agent is less likely to accumulate in a particular region of the print agent distributor, thereby reducing the likelihood of a print defect occurring.

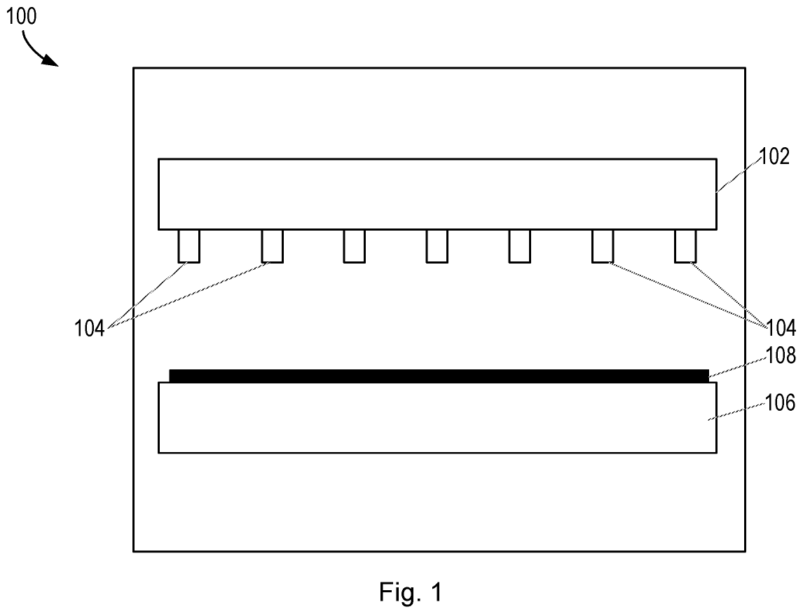

Referring to the drawings, FIG. 1 is a schematic illustration of an example of a print apparatus 100. The print apparatus 100 comprises a print agent distributor 102 having a plurality of nozzles 104 through which print agent is to be delivered during a printing operation. While, in this example, very few nozzles 104 are shown for clarity, it will be understood that the print agent distributor may contain many thousands of nozzles, each capable of depositing drops of print agent during a printing operation. The print apparatus 100 also comprises a maintenance unit 106 having a print agent receiving surface 108 to receive print agent from nozzles 104 of the print agent distributor 102 during a maintenance event. During the maintenance event, the print agent receiving surface 108 and the plurality of nozzles 104 are to contact one another and move relative to one another in a first direction and in a second direction which is not parallel to the first direction. The movement may be such that print agent is transferred from nozzles of the print agent distributor onto the print agent receiving surface. For example, the movement in the first direction and in the second direction may be simultaneous. By moving the nozzles 104 of the print agent distributor 102 relative to the print agent receiving surface 108 (and/or by moving the print agent receiving surface relative to the nozzles) in two non-parallel directions, print agent from the nozzles is spread more widely over the print agent receiving surface, and accumulation of print agent on the print agent distributor as a result of wiping is less likely to occur.

In some examples, the nozzles 104 of the print agent distributor 102 may be moved in a first direction relative to the print agent receiving surface 108, then in a second direction relative to the print agent receiving surface. In some examples, this movement pattern may be repeated, such that the nozzles are moved in the first direction, then in the second direction. In other examples, following movement in the second direction, the nozzles 104 may be moved in a third direction relative to the print agent receiving surface 108, a fourth direction, and so on.

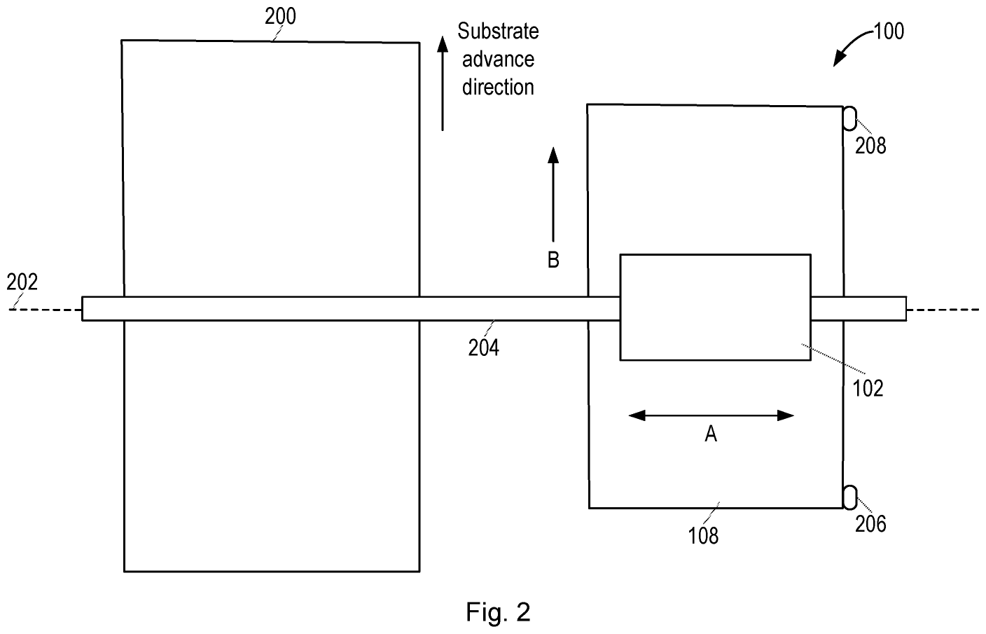

FIG. 2 is a schematic plan view illustration of a further example of the print apparatus 100. During a printing operation, the print agent distributor 102 scans back and forth over a printable substrate 200 along an axis 202, in the directions indicated by the double-headed arrow A. For example, the print agent distributor 102 may travel in a carriage along a track or rail 204. As the print agent distributor 102 scans over the printable substrate 200, print agent can be deposited through the nozzles 104. The printable substrate 200 may advance in a substrate advance direction as indicated by the arrow in FIG. 2. Intermittently, after several passes over the printable substrate 200, the print agent at distributor 102 may be moved into the position shown in FIG. 2, such that the nozzles 104 of the print agent distributor are in contact with the print agent receiving surface 108. In this example, the print agent receiving surface 108 comprises a web of material held on rollers 206 and 208. For example, clean material may be stored on the roller 206 and, after it has been used to wipe the nozzles, the material may be rolled onto the roller 208. While the nozzles 104 of the print agent distributor 102 are in contact with the print agent receiving surface 108, the print agent receiving surface is moved in a direction shown by arrow B, for example by rotating the rollers 206, 208, such that the print agent receiving surface (e.g. the web material) is rolled onto the roller 208. Thus, in this example, the relative movement of the print agent receiving surface 108 and the nozzles 104 in the direction shown by the arrow B constitutes the movement in the first direction.

As the print agent receiving surface 108 is moved in a direction shown by the arrow B, relative movement in a second, non-parallel direction is achieved by moving the print agent distributor 102. The print agent distributor 102 may, for example, be moved a distance along the rail 204, such that the nozzles remain in contact with the print agent receiving surface 108. In some examples, the print agent distributor 102 may be moved back and forth along the rail 204, in both directions indicated by the double-headed arrow A, while the print agent receiving surface 108 is moved in the direction indicated by the arrow B. Thus, in some examples, the print agent distributor 102 may be to move in an oscillatory manner along an axis 202 which is not parallel to the first direction (e.g. indicated by the arrow B) while the print agent receiving surface 108 and the nozzles 104 are moved relative to one another in the first direction. Movement of the print agent distributor 102 along the rail 204 may be controlled using a controller or processor (not shown in FIG. 2) of the print apparatus 100. The same controller or processor may be used to control the oscillatory motion of the print agent distributor 102 during the maintenance event.

Thus, as shown in the example of FIG. 2, the print agent receiving surface 108 may comprise a web to move in the first direction while the nozzles 104 are moved in the second direction.

In general, the second direction may be any direction that is not parallel to the first direction. Thus, in the example shown in FIG. 2, the second direction may be any direction that is not the direction shown by the arrow B or directly opposite to the direction shown by the arrow B. In some examples, however, the second direction may be orthogonal (or substantially orthogonal) to the first direction, such as in the example shown in FIG. 2.

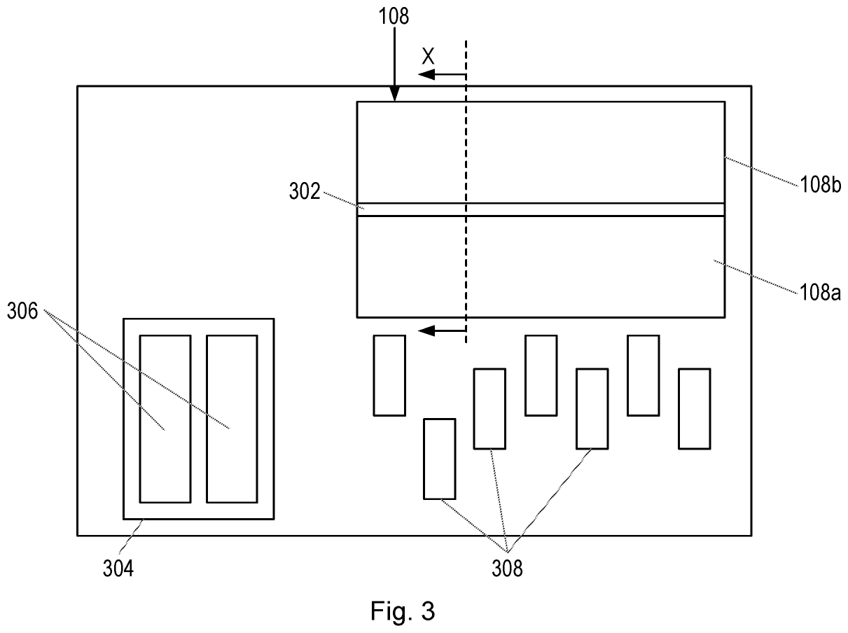

The maintenance unit 106, of which the print agent receiving surface 108 forms one component, may include other components that are used to perform other maintenance functions in respect of the print agent distributor 102 during a maintenance event. FIG. 3 is a schematic illustration of an example of the maintenance unit 106, which includes the print agent receiving surface 108. In this example, the print agent receiving surface 108 comprises a web, as discussed above, and includes two distinct regions 108a and 108b, separated by a provider (e.g. a roller) 302. In this example, the region 108a is a wiping region on which the nozzles 104 are wiped during the maintenance event and the region 108b is a spitting region, onto which print agent may be deposited from nozzles during a spitting procedure. In other examples, the print agent receiving surface 108 may include just one region (e.g. the wiping region), or may include additional regions. The maintenance unit 106 also includes a receptacle 304 which may also receive print agent deposited from nozzles 104 during a spitting procedure. A pair of rollers 306 may be provided to reduce or prevent aerosol generation during the spitting procedure. The rollers 306 may be rotated in opposite directions relative to one another, such that print agent deposited during the spitting procedure is received in the receptacle 304 between the rollers. The maintenance unit 106 may also include a plurality of nozzle capping units 308. Each nozzle capping unit 308 may receive a die of the print agent distributor 102 during a maintenance event, or while the print agent distributor is not in use. When the dies and the nozzles 104 are enclosed within the nozzle capping units 308, the nozzles may be protected, and evaporation and drying of print agent on the nozzles may be prevented.

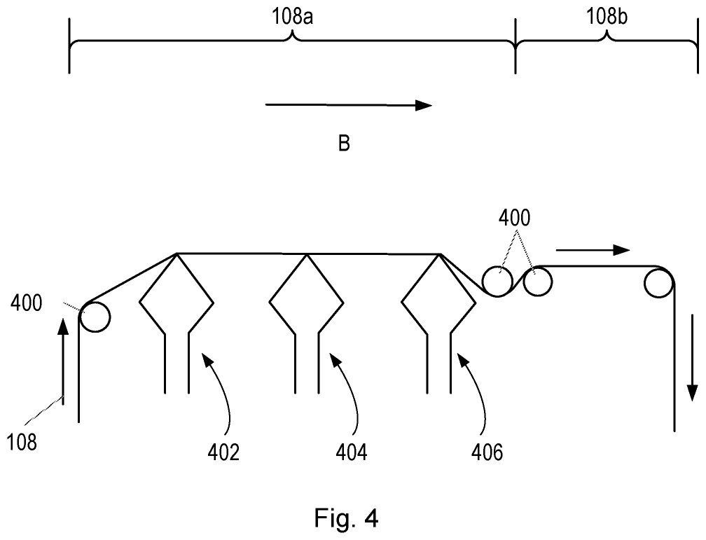

FIG. 4 is a schematic illustration of a sectional view of the print agent receiving surface 108 through the line X of FIG. 3. During a maintenance event, the print agent receiving surface 108 (e.g. a web material in this example) moves over a series of rollers 400 as shown, such that the general direction of movement is in the direction indicated by the arrow B. The wiping region 108a and the spitting region 108b of the print agent receiving surface 108 are indicated in FIG. 4. To assist with effective wiping of the nozzles on the print agent receiving surface 108, the print agent receiving surface may be urged towards the nozzles. In some examples, such as the example shown in FIG. 4, maintenance unit 106 may comprise a plurality of blades 402, 404, 406 to urge the print agent receiving surface 108 towards the nozzles 104 while the print agent receiving surface and the nozzles 104 are in contact with one another. The blades 402, 404, 406 work in conjunction with the rollers 400 to cause the print agent receiving surface 108 to remain taught in the wiping region 108a. When the print agent receiving surface 108 is moved (e.g. rolled onto the roller 208 from the roller 206 in the example of FIG. 2), the print agent receiving surface moves over the blades 402, 404, 406. In some examples, the maintenance unit 106 may comprise at least three blades 402, 404, 406. Thus, while the maintenance unit 106 shown in the example shown in FIG. 4 comprises a first blade 402, a second blade 404 and a third blade 406, in other examples, the maintenance unit may comprise more blades. By providing at least three blades to urge the print agent receiving surface 108 towards the nozzles 104, the force applied to the nozzles by each blade is less than if fewer blades were used. In other words, the force applied to the nozzles is spread out over the blades, such that a large force is not applied by any one blade, thereby reducing the likelihood that nozzles will be damaged by the force applied by blade. The blades may be made from rubber or plastics material. With the arrangement shown in FIG. 4, the print agent receiving surface 108 (e.g. the web material) will first engage and wipe the nozzles 104 above the first blade 402 before moving in the direction shown by the arrow B over the second blade 404 and the third blade 406. Thus, as the print agent receiving surface 108 reaches the position of the second and third blades 404, 406, the receiving surface may already have received print agent from the nozzles 104.

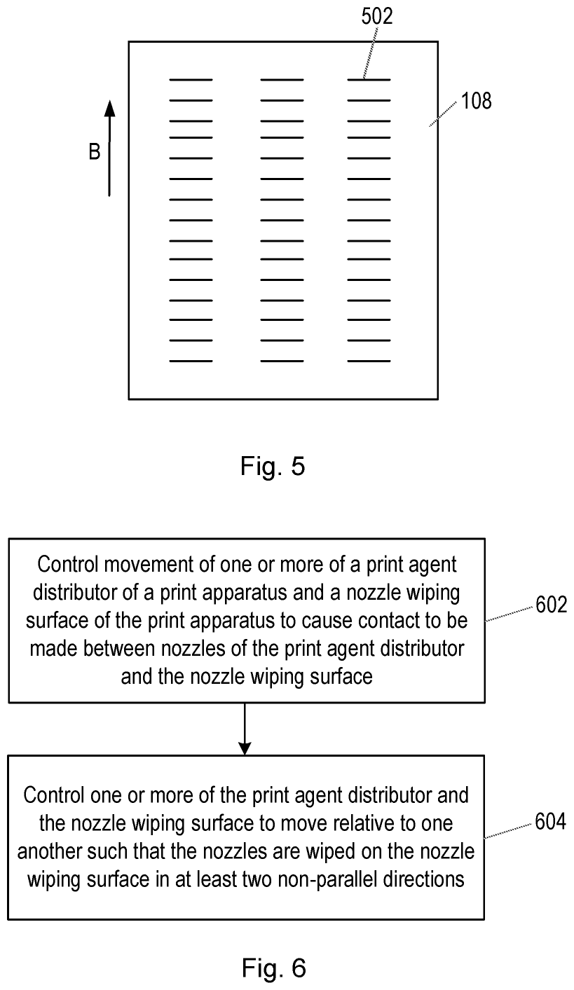

An effect of moving the nozzles 104 and the print agent receiving surface 108 in multiple, non-parallel directions relative to one another during a maintenance event is that print agent is wiped onto the print agent receiving surface in at least two, non-parallel directions. In some examples, the nozzles 104 are wiped onto the portion of the print agent receiving surface 108 directly over the blades 402, 404, 406, or other element used to urge the print agent receiving surface towards the nozzles. Thus, in some cases, just the portion of the print agent receiving surface 108 directly over the urging element or blades 402, 404, 406 may receive print agent during a wiping event. After the nozzles have been wiped, causing lines of print agent to form on the portion of the print agent receiving surface 108 directly over the urging element or blades 402, 404, 406, the print agent receiving surface may be advanced (e.g. rolled onto the roller 208), such that, when the nozzles 104 are next wiped onto the print agent receiving surface, a clean portion of the print agent receiving surface is over the blades 402, 404, 406, and is used to wipe the nozzles. FIG. 5 is an illustration of an example of a pattern 502 formed by print agent on the print agent receiving surface 108 as a result of the nozzles 104 being wiped on the print agent receiving surface in at least two non-parallel directions, in the manner described above. In this example, the pattern on the print agent receiving surface 108 is formed as a result of the print agent distributor 102 moving in the second direction and in a direction opposite to the second direction by oscillating back and forth along the axis 202 (see FIG. 2) while the print agent receiving surface is moved in the direction indicated by the arrow B. Print agent is wiped in lines along the portion of the print agent receiving surface over the blades 402, 404, 406. The resulting pattern, as shown in FIG. 5, is in the form of a series of parallel lines for each print head (each print head including a set of nozzles). In FIG. 5, the patterns formed by three print heads are shown. Print agent wiped from the nozzles 104 onto the print agent receiving surface 108 is therefore spread in lines across the print agent receiving surface, which are longer than the lines would be if the print agent distributor 102 were not moved along the axis 202 during the maintenance event.

The present disclosure also relates to a method, such as a nozzle-maintenance method, or a method of wiping nozzles. The method may, in some examples, comprise a computer implemented method. FIG. 6 is a flowchart of an example of such a method 600. The method 600 comprises, at block 602, controlling movement of one or more of a print agent distributor 102 of a print apparatus 100 and a nozzle wiping surface of the print apparatus to cause contact to be made between nozzles 104 of the print agent distributor and the nozzle wiping surface. The nozzle wiping surface may comprise the print agent receiving surface 108 discussed above. At block 604, the method 600 comprises controlling one or more of the print agent distributor 102 and the nozzle wiping surface to move relative to one another such that the nozzles 104 are wiped on the nozzle wiping surface in at least two non-parallel directions. As discussed above, wiping the nozzles 104 on the nozzle wiping surface in two or more different, non-parallel directions helps to spread the print agent over a larger area of the nozzle wiping surface, resulting in less build-up of print agent on the print agent distributor 102.

In some examples, controlling (block 604) one or more of the print agent distributor 102 and the nozzle wiping surface to move relative to one another may comprise moving the nozzle wiping surface in a direction parallel to a first axis, and moving the print agent distributor in a direction parallel to a second axis that is not parallel to the first axis. For example, the nozzle wiping surface may be moved in a direction indicated by the arrow B (see FIGS. 2, 4 and 5) and the print agent distributor 102 may be moved in one or more directions (e.g. back and forth) along the axis 202 (see FIG. 2), which is not parallel to the direction indicated by the arrow B. Moving the print agent distributor 102 may, in some examples, comprise oscillating the print agent distributor along the second axis. For example, movement of the print agent distributor 102 may be controlled to cause print agent distributor to move rapidly back and forth along a second axis that is not parallel to the first axis. In some examples, the second axis may be perpendicular (or substantially perpendicular) to the first axis is in the example shown in FIG. 2. In other examples, however, the second axis may be at any other non-zero angle relative to the first axis.

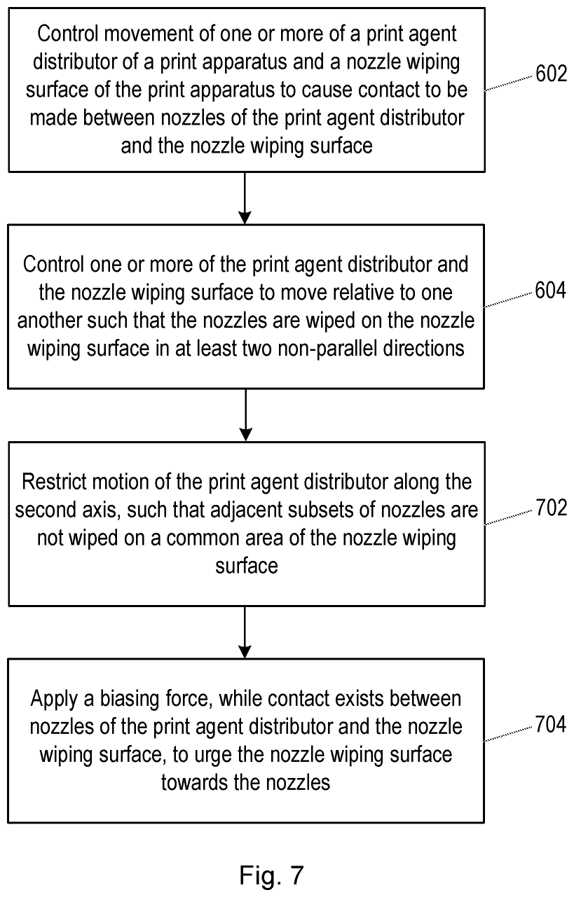

As noted above, nozzles 104 of the print agent distributor 102 may be grouped in one or more subsets, formed on or as part of one or more dies of the print agent distributor. Nozzles of a particular die may deposit print agent of a particular color and, in some examples, print agent of a particular color may be deposited by nozzles from a plurality of dies. To prevent cross-contamination of print agent of different colors, lateral movement (i.e. movement in the direction(s) parallel to the second axis) of the print agent distributor 102 may be restricted such that nozzles of two different dies are not wiped on the same part of the nozzle wiping surface. In this way, nozzles that deposit print agent of a first color (e.g. red) are not wiped on the same part of the nozzle wiping surface as nozzles that deposit print agent of a second color (e.g. blue). This reduces the chance of blue print agent contaminating nozzles used for red print agent, and so on. To prevent such cross-contamination, the movement of the print agent distributor 102 in the direction(s) parallel to the second axis may be limited or restricted. For example, the controller or processor used to control the movement of the print agent distributor 102 limits the movement to within defined boundaries. FIG. 7 is a flowchart of a further example 700 of a method, such as a method of wiping nozzles, which includes blocks relating to restricting the movement of the print agent distributor 102. The method 700 may contain a block or blocks of the method 600 discussed above. The print agent distributor 102 may comprise a plurality of sub-sets of nozzles. The method 700 may further comprise, at block 702, restricting motion of the print agent distributor 102 along the second axis, such that adjacent subsets of nozzles are not wiped on a common area of the nozzle wiping surface. In other words, adjacent subsets of nozzles are not wiped on the same area of the nozzle wiping surface, thereby reducing the likelihood of cross contamination of print agent.

At block 704, the method 700 may further comprise applying a biasing force, while contact exists between nozzles 104 of the print agent distributor 102 and the nozzle wiping surface, to urge the nozzle wiping surface towards the nozzles. In some examples, the biasing force may be applied using a plurality of blades, such as the blades 402, 404, 406 shown in FIG. 4. In some examples, at least three blades may be used to apply the biasing force to the nozzle wiping surface. In other examples, other mechanisms may be used to apply a biasing force.

As noted above, a consequence of moving the print agent distributor 102 and the nozzle wiping surface relative to one another in the manner discussed herein is that the nozzles 104 are wiped over a greater surface area of the nozzle wiping surface as compared with a nozzle wiping procedure in which the nozzles are wiped in a single direction. Thus, in some examples, the nozzles 104 may be wiped on the nozzle wiping surface such that, relative to one another, the nozzles and the nozzle wiping surface move in a zigzag pattern. Such a movement may cause print agent to be wiped onto portions of the nozzle wiping surface that are directly over the blades 402, 404, 406, forming a series of parallel lines for each print head. For example, nozzles may be wiped in such a way that the print agent wiped from the nozzles 104 forms a pattern as shown in FIG. 5.

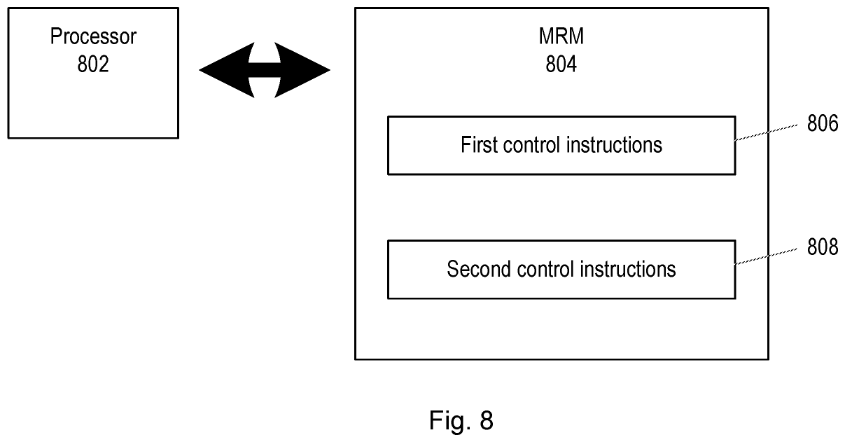

The present disclosure also relates to a machine-readable medium. FIG. 8 is a schematic illustration of an example of a processor 802 in communication with a machine-readable medium 804. The machine-readable medium 804 comprises instructions which, when executed by a processor 802, cause the processor to perform functions, such as the functions described in the blocks of the methods 600, 700 disclosed herein. In one example, the machine-readable medium 804 comprises first control instructions 806 which, when executed by the processor 802, cause the processor to control a print agent distributor 102 to move into a position such that nozzles 104 of the print agent distributor are in contact with a wiping surface. The wiping surface may, for example, comprise the print agent receiving surface 108 or the nozzle wiping surface discussed herein. The machine-readable medium 804 may comprise second control instructions 808 which, when executed by the processor 802, cause the processor to control one or more of the print agent distributor 102 and the wiping surface to move in two non-parallel directions relative to one another, so as to wipe nozzles 104 of the print agent distributor on the wiping surface.

The processor 802 may, in some examples, comprise a processor of the print apparatus 100. For example, the processor 802 may perform other control functions, such as controlling the distribution of print agent from the nozzles during a printing operation.

In some examples, the instructions which cause the processor 802 to control one or more of the print agent distributor 102 and the wiping surface to move in to non-parallel directions relative to one another (e.g. the instructions 808) may comprise instructions which cause the processor to initiate movement of the wiping surface in a first direction relative to the print agent distributor, and initiate movement of the print agent distributor in at least one reciprocation cycle along an axis that is not parallel to the first direction. The first direction may, for example, comprise the direction indicated by the arrow B in FIGS. 2, 4 and 5. Thus, the wiping surface may be moved in the manner discussed above, responsive to the initiation of the movement of the wiping surface. The movement of the print agent distributor 102 may be initiated simultaneously with the movement of the wiping surface, for example by the processor 802 sending simultaneous control signals to the appropriate mechanisms to effect movement of the wiping surface and the print agent distributor. In other words, the initiation of movement of the wiping surface and the print agent distributor may be synchronized. In some examples, the movement may be synchronized such that the wiping surface and the print agent distributor start to move simultaneously and stop moving simultaneously. A reciprocation cycle of print agent distributor 102 may, for example, involve moving the print agent distributor by a distance L from a starting position in a first direction along the axis 202, then moving the print agent distributor in the opposite direction to a distance L the other side of the starting position, then moving the print agent distributor back to its original starting position. Such a movement, when combined with the movement of the wiping surface, would result in a Z-shaped pattern of print agent being formed on the wiping surface. In some examples, the print agent distributor 102 may be moved in at least two reciprocation cycles during a maintenance event.

Examples disclosed herein provide a mechanism by which nozzles of a print agent distributor (e.g. a print head) of a print apparatus may be wiped in an effective manner, such that print agent does not accumulate on the print head, thereby improving the longevity of the print head. By wiping the nozzles in the disclosed manner, the likelihood of print defects occurring is reduced. Furthermore, since the nozzles of the print head are wiped over a larger surface area of the nozzle wiping surface, the life of the nozzle wiping surface is also increased relative to a nozzle wiping technique in which nozzles are wiped in a single, linear direction. A further result of the improved wiping of the nozzles is that the frequency of the nozzle wiping events (i.e. the maintenance events) can be reduced, leading to improved printing throughput.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A print apparatus comprising:
a print agent distributor having a plurality of nozzles through which print agent is to be delivered during a printing operation; and
a maintenance unit having a print agent receiving surface to receive print agent from nozzles of the print agent distributor during a maintenance event;
wherein, during the maintenance event, the print agent receiving surface and the plurality of nozzles are to contact one another and move relative to one another in a first direction and in a second direction which is not parallel to the first direction.

2. A print apparatus according to claim 1, wherein the print agent distributor is to move in an oscillatory manner along an axis which is not parallel to the first direction while the print agent receiving surface and the nozzles are moved relative to one another in the first direction.

3. A print apparatus according to claim 1, wherein second direction is orthogonal to the first direction.

4. A print apparatus according to claim 1, wherein maintenance unit comprises a plurality of blades to urge the print agent receiving surface towards the nozzles while the print agent receiving surface and the nozzles are in contact with one another.

5. A print apparatus according to claim 4, wherein the maintenance unit comprises at least three blades.

6. A print apparatus according to claim 1, wherein the print agent receiving surface comprises a web to move in the first direction while the nozzles are moved in the second direction.

7. A computer-implemented method comprising:
controlling movement of one or more of a print agent distributor of a print apparatus and a nozzle wiping surface of the print apparatus to cause contact to be made between nozzles of the print agent distributor and the nozzle wiping surface; and
controlling one or more of the print agent distributor and the nozzle wiping surface to move relative to one another such that the nozzles are wiped on the nozzle wiping surface in at least two non-parallel directions.

8. A computer-implemented method according to claim 7, wherein controlling one or more of the print agent distributor and the nozzle wiping surface to move relative to one another comprises moving the nozzle wiping surface in a direction parallel to a first axis, and moving the print agent distributor in a direction parallel to a second axis that is not parallel to the first axis.

9. A computer-implemented method according to claim 8, wherein moving the print agent distributor comprises oscillating the print agent distributor along the second axis.

10. A computer-implemented method according to claim 8, wherein the second axis is substantially perpendicular to the first axis.

11. A computer-implemented method according to claim 7, wherein the print agent distributor comprises a plurality of subsets of nozzles, and wherein the method further comprises:
restricting motion of the print agent distributor along the second axis, such that adjacent subsets of nozzles are not wiped on a common area of the nozzle wiping surface.

12. A computer-implemented method according to claim 7, further comprising:
applying a biasing force, while contact exists between nozzles of the print agent distributor and the nozzle wiping surface, to urge the nozzle wiping surface towards the nozzles.

13. A computer-implemented method according to claim 7, wherein the nozzles and the nozzle wiping surface are moved in a zigzag pattern relative to one another.

14. A machine-readable medium comprising instructions which, when executed by a processor, cause the processor to:
control a print agent distributor to move into a position such that nozzles of the print agent distributor are in contact with a wiping surface; and
control one or more of the print agent distributor and the wiping surface to move in two non-parallel directions relative to one another, so as to wipe nozzles of the print agent distributor on the wiping surface.

15. A machine-readable medium according to claim 14, wherein the instruction which cause the processor to control one or more of the print agent distributor and the wiping surface to move in two non-parallel directions relative to one another comprise instructions which cause the processor to:
initiate movement of the wiping surface in a first direction relative to the print agent distributor; and
initiate movement of the print agent distributor in at least one reciprocation cycle along an axis that is not parallel to the first direction.
